(19) United States
(12) Patent Application Publication
(10) Pub. No.: US 2009/0308902 A1
(43) Pub. Date: Dec. 17, 2009

(54) Surfboard Carrier

(76) Inventor: Michael D. Rex, San Diego, CA (US)

Correspondence Address: QUICKPATENTS, INC., 32861 CALLE PERFECTO, SUITE A, SAN JUAN CAPISTRANO, CA, 92675, US

(21) Appl. No.: 12/138,878

(22) Filed: Jun. 13, 2008

(51) Int. Cl. B60R 9/055; B60R 9/08; B60R 9/048; B60R 9/05

(52) U.S. Cl. 224/315; 224/328; 224/316; 224/324; 34/359

(57) ABSTRACT

A container for at least one surfboard is disclosed. The container includes a top shell having at least one hollow projection projecting outwardly from the outside surface and a bottom shell pivotally connected to the top shell with at least one hinge means. Each fin projection is adapted to receive at least one of the fins of each surfboard. The container is provided with at least one air inlet aperture and at least one air exhaust aperture. The bottom shell may further include a rack fixed to the inside surface to securely hold at least one wetsuit, towel, or other item. The invention further includes a vehicle attachment means adapted to secure the container to the vehicle.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE INVENTION

This invention relates to vehicle-carried containers, and more particularly to a container for transporting and drying surfboards and other related items.

### DISCUSSION OF RELATED ART

A surfer has various needs for safekeeping his surfboard during both storage and traveling. When a surfer is traveling by car, his surfboard can be stored and transported on top of the car using a conventional, un-enclosed surfboard rack. Since the surfboard is sensitive to damage from road debris, care should be taken while transporting. Such open racks of the prior art do not protect surfboards from damage from road debris and are also vulnerable to theft.

There are several different types of enclosed item carriers that could be used to transport a surfboard and protect the board from damage and theft. However, such enclosed item carriers of the prior art are typically larger than necessary for holding surfboards, and may not fit on many vehicles. Further, such carriers are typically substantially sealed, and provide no means by which to dry items carried within while driving. Even further, as surfboards are delicate and subject to denting, shattering and other damage, transporting a surfboard in such a carrier would likely result in damage to the surfboard.

Several prior art devices are known for the storage and transportation of the surfboard. For example, U.S. Pat. No. 6,230,951 to Anderson on May 15, 2001, provides a bag for storing, carrying or holding a surfboard on top of a vehicle. The bag can be carried by handle or by an attachable shoulder strap and can attach to the vehicle roof by using just two or four straps. Such a bag is not capable of being fastened to the top of the vehicle without a pre-installed hard rack on the vehicle.

More portable solutions for providing conventional racks for skis and surfboards for roof carried items are found in U.S. Pat. No. 4,717,055 to San Juan on Jan. 5, 1988, and in U.S. Pat. No. 4,396,138 to Kirschner on Aug. 2, 1983. These racks include an elongate cord extending across the vehicle and hook members for attaching ends of cord to the vehicle. However, these racks are not well suited as portable device for securing surfboards and the like. The surfboard must be secured to the roof rack with straps or cords which must be tied down on each side. This is a complicated procedure. When driving the vehicle at speed, a surfboard or other planar or sail-shaped item will tend to tilt or vibrate up and down, and the free strap ends will also be a distraction.

U.S. Pat. No. 5,067,644 to Coleman on Jun. 23, 1998, discloses a device for attaching elongated items such as skis or surfboards to a vehicle roof or roof rack. The device includes a pair of C-shaped, tubular sleeve members secured around crossbars of a roof rack, and a surfboard secured on top of the foam sleeves by straps. However, this is still not a stable arrangement, since the foam sleeves may still rotate or move along the crossbar, allowing movement of the board.

U.S. Pat. No. 4,896,519 to Pitts on Jan. 30, 1990 explains a method for locking the surfboard to a vehicle that includes steps to encase the surfboard locked in the locking apparatus and attached by cable closed in the locked door of a vehicle. Such a device is relatively portable, yet includes complicated configuration steps to set up because of its inherent design complexity.

Therefore, there is a need for a device that is particularly adapted for transporting and drying surfboards and other related items simultaneously. Further, such a device would be a container which optimizes the required space without spoiling the appearance of the vehicle and would further be a stable arrangement. Such a needed device would protect the items from damage from road debris and would be theft resistant. Moreover, such a needed device would be portable and easy to attach to the top of a vehicle with simple configuration steps. The present invention accomplishes these objectives.

### SUMMARY OF THE INVENTION

The present device is a container adapted particularly for transporting at least one surfboard having at least one fin, as well as other related items such as wetsuits, towels, or the like. The container includes a top shell open at a lower side that includes an inside surface, an outside surface, and at least one hollow projection projecting outwardly from the outside surface proximate a rear end thereof. Each fin projection is adapted to receive at least one of the fins of each surfboard and is tapered toward a forward end to reduce aerodynamic drag on the container when a vehicle to which the container is attached is in motion. The top shell is provided with at least one air inlet aperture through a front end and at least one air exhaust aperture through the rear end, respectively. As such, air enters the container through each air inlet aperture and exits the container through each air exhaust aperture when the vehicle is in motion, the air flow being useful for drying the items in the container.

A bottom shell open at an upper side is further included that is pivotally connected to the top shell with at least one hinge means. As such, in a closed position the open sides of the top and bottom shells come together to form the closed container. The bottom shell has an inside surface and an outside surface. A plurality of drainage apertures is provided at a lower side of the bottom shell. The invention has at least one latch mechanism fixed to each shell that is adapted to secure each shell to the other, and the latch mechanism preferably includes a mechanical locking means. The bottom shell may further include a rack fixed to the inside surface to securely hold at least one wetsuit, towel, or other item. The invention further includes a vehicle attachment means fixed to the bottom shell that is adapted to secure the container to the vehicle. In use, with the container secured to the vehicle, the top shell may be lowered to engage the bottom shell to contain each surfboard or other item therein. While driving the vehicle, the air passes through the container to dry each item.

The present invention is a container that is particularly adapted for transporting and drying surfboards and other related items simultaneously. Further, such a container optimizes the required space without spoiling the appearance of the vehicle and further is not unstable, as are some of the prior art devices. The present invention protects the carried items from damage from road debris and is also theft resistant. Moreover, the components of the invention are useful and easy to attach to the top of a vehicle with simple configuration steps. Further, the invention can lock valuables such as car keys, wallets, or the like inside the container when the invention includes a keyless locking latching means. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a right-side elevational view of the invention, illustrated in a closed configuration;

FIG. 2 is a top plan view of the invention, illustrated in the closed configuration;

FIG. 3 is a top plan view of the invention, illustrated in an open configuration;

FIG. 4 is a right-side elevational view of the invention, illustrated as attached to a vehicle;

FIG. 5A is a front elevational view of a latch mechanism of the invention; and

FIG. 5B is a front elevational view of an alternate embodiment of the latch mechanism of the invention.

### DETAILED DESCRIPTION OF THE PREFERRED EMBODIMENT

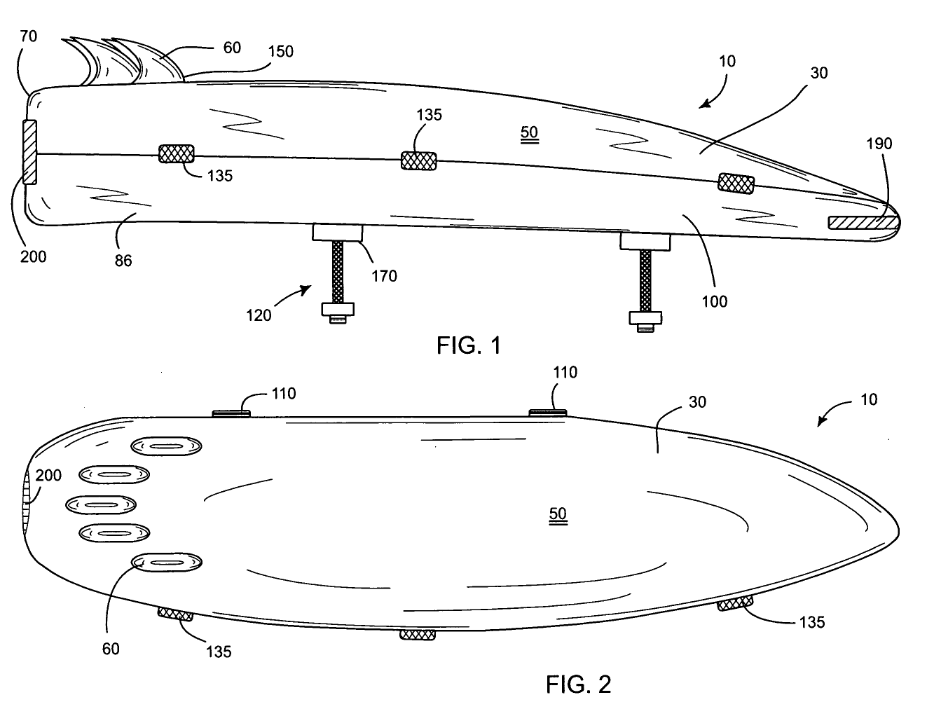

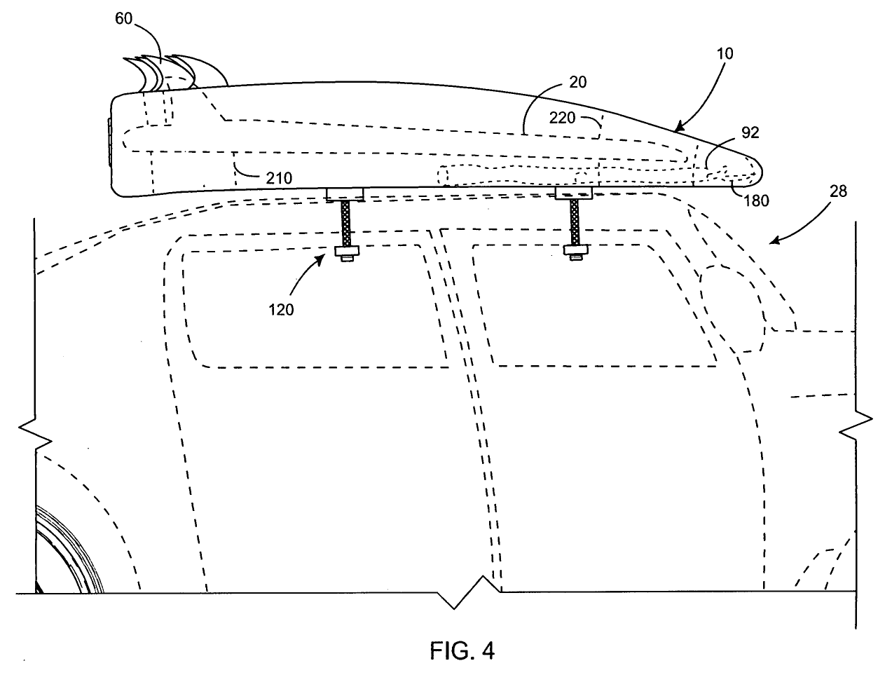

FIGS. 1 and 4 illustrate a container 10 for at least one surfboard 20. Each surfboard 20 typically has at least one fin 25, but may include three or even more fins 25. The container 10 includes a top shell 30 that is open at a lower side 32. The top shell 30 includes an inside surface 40, an outside surface 50, and at least one hollow projection 60 projecting outwardly from the outside surface 50 proximate a rear end 70 thereof. Each fin projection 60 is adapted to receive at least one of the fins 25 of at least one surfboard 20. Each fin projection 60 is also tapered toward a forward end 150 thereof to reduce aerodynamic drag on the container 10 when the vehicle 28 to which the container 10 is attached is in motion.

The top shell 30 is provided with at least one air inlet aperture 190 through a front end 72 and at least one air exhaust aperture 200 through the rear end 70 respectively. The air enters the container 10 through each air inlet aperture 190 and exits the container 10 through each exhaust aperture 200 when the vehicle 28 is in motion.

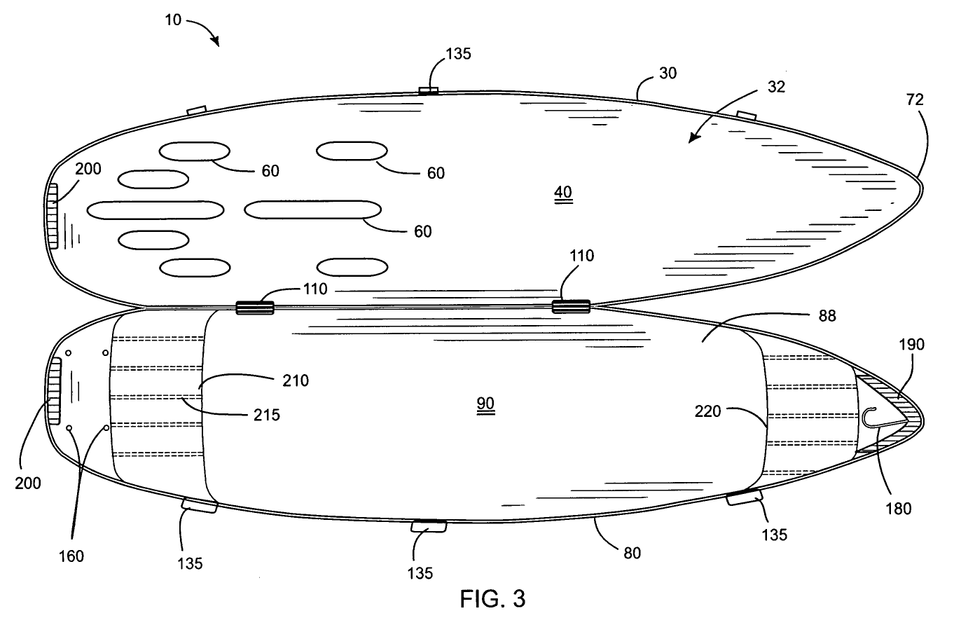

A bottom shell 80, open at an upper side 88 thereof, is further included that is pivotally connected to the top shell 30 with at least one hinge means 110 (FIG. 2). As such, in a closed position (FIG. 3) the open sides 32,88 of the top and bottom shells 30,80 come together to form the closed container 10. The bottom shell 80 has an inside surface 90 and an outside surface 100. A plurality of drainage apertures 160 may also be provided at a lower side 86 of the bottom shell 80.

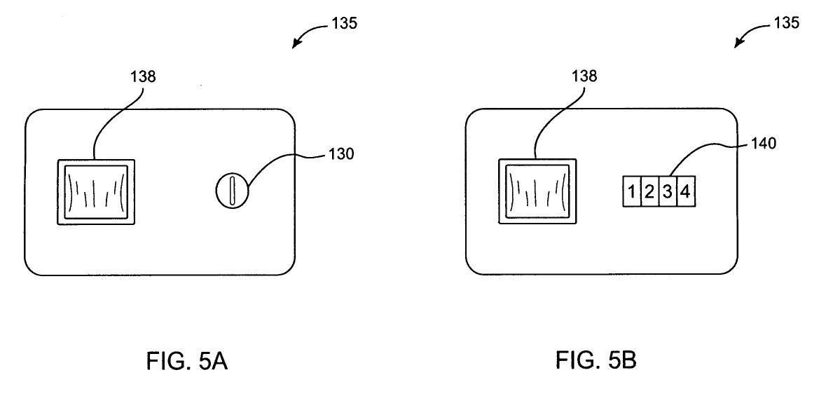

The invention has at least one latch mechanism 135 (FIG. 5A) fixed to each shell 30,80 that is adapted to secure each shell 30,80 to the other, and the latch mechanism 135 may further include a mechanical locking means 130, such as a keyed cylinder, to guard the contents of the container 10 against theft or inadvertent opening while traveling. In the preferred embodiment, at least one of the locking means 130 is a keyless numerical combination lock 140 (FIG. 5B). A latch button 138 may be used to open the latch mechanism 135, as is known in the art.

The bottom shell 80 further includes a rack 180 fixed to the inside surface 90 to securely hold at least one wetsuit 92, towel (not shown), or other items as may be desired. The bottom shell 80 may also provided with at least one air inlet aperture 190 through a front end 102 and at least one of air exhaust aperture 200 through a rear end 104. The air enters the container 10 through each air inlet aperture 190 and exits the container 10 through each air exhaust aperture 200 when the vehicle 28 is in motion. Thus, the air passes through the container 10 when the container 10 is in the closed position and vehicle 28 is in motion to dry each wetsuit 92, surfboard 20, and any other item in the container 10.

The invention further includes a vehicle attachment means 120 fixed to the bottom shell 80 that is adapted to secure the container 10 to the vehicle 28. In one embodiment of the invention, the attachment means 120 includes a metal bracket 170. Alternately, the attachment means 120 may be a nylon strap, or the like, as is known in the art. Clearly, the container 10 may also be secured to existing car racks (not shown) with the attachment means 120.

The invention may further include foam inserts 210, 220 (FIG. 3), or the like, for padding each surfboard 20 within the container 10. As such, each shell 30,80 may be made from a rigid material, such as rigid plastic, or the like, and the foam inserts 210,220 keep each surfboard 20 from contacting the shells 30,80 while the vehicle 28 is moving. Such foam inserts 210,220 may include pockets 215 for receiving each surfboard 20 therein, and the user may customize such inserts 210,220 to fit any particular surfboard 20.

In use, with the container 10 secured to the vehicle 28, the top shell 30 may be lowered to engage the bottom shell 80 to contain each surfboard 20, wetsuit 92, or other items therein. While driving the vehicle 28, the air passes through the container 10 to dry contents of the container 10 while keeping the contents retained safely therein.

While a particular form of the invention has been illustrated and described, it will be apparent that various modifications can be made without departing from the spirit and scope of the invention. For example, the container 10 may be manufactured in various shapes and sizes in order to accommodate multiple surfboards and surfboard types simultaneously. Accordingly, it is not intended that the invention be limited, except as by the appended claims.

What is claimed is:

1. A container for at least one surfboard each having at least one fin, the container for attaching to a vehicle, and comprising:
a top shell open at a lower side and having an inside surface, an outside surface, and at least one hollow fin projection projecting outwardly from the outside surface of the top shell proximate a rear end thereof, each fin projection for receiving the at least one fin of each surfboard;
a bottom shell open at an upper side and having an inside surface, an outside surface, the bottom shell pivotally connected to the top enclosure with at least one hinge means such that in a closed position the open sides of the top and bottom shells come together, the top and bottom shells thereby forming a closed container; and
a vehicle attachment means fixed to the bottom shell and adapted to secure the container to the vehicle;
whereby with the container secured to the vehicle, the top enclosure may be lowered to engage the bottom enclosure to contain each surfboard therein.

2. The container of claim 1 further including at least one latch mechanism fixed to each shell and cooperating to secure each shell to the other.

3. The container of claim 2 wherein at least one of the latch mechanisms includes a mechanical locking means.

4. The container of claim 3 wherein at least one of the locking means is a numerical combination lock.

5. The container of claim 1 wherein each fin projection is tapered toward a forward end to reduce aerodynamic drag on the container when the vehicle is in motion.

6. The container of claim 1 wherein the bottom shell has a plurality of drainage apertures at a lower side for allowing drainage of water therethrough.

7. The container of claim 1 wherein the vehicle attachment means is at least one metal bracket.

8. The container of claim 1 further include a rack fixed to the inside surface of the bottom shell, the rack adapted to securely hold at least one wetsuit.

9. The container of claim 1 further including at least one air inlet aperture through a front end of the top shell, whereby air may enter the container when the vehicle is in motion.

10. The container of claim 1 further including at least one air inlet aperture through a front end of the bottom shell, whereby air may enter the container when the vehicle is in motion.

11. The container of claim 1 further including at least one air exhaust aperture through the rear end of the top shell, whereby air may exit the container when the vehicle is in motion.

12. The container of claim 1 further including at least one air exhaust aperture through a rear end of the bottom shell, whereby air may exit the container when the vehicle is in motion.

13. The container of claim 8 further including at least one air inlet aperture through a front end of either of the shells and at least one air exhaust aperture through a rear end of either of the shells, whereby air may pass through the container when the container is in the closed position and vehicle is in motion to dry at least one of the wetsuit and at least one of the surfboard.

14. A method of transporting and drying at least one item, comprising:
a) providing the container as recited in claim 13;
b) securing the container to the vehicle with the vehicle attachment means;
c) putting the at least one item into the container;
d) closing the container; and
e) driving the vehicle to allow air to pass through the container to dry the at least one item.
